(19) United States
(12) Patent Application Publication
(10) Pub. No.: US 2006/0157115 A1
(43) Pub. Date: Jul. 20, 2006

(54) Regulator with belleville springs

(76) Inventors: Andrew Dorogi, Lancaster, NY (US); Dennis P. Pietrantoni, Lancaster, NY (US)

Correspondence Address: HODGSON RUSS LLP, ONE M & T PLAZA, SUITE 2000, BUFFALO, NY, 14203-2391, US

(21) Appl. No.: 11/329,532

(22) Filed: Jan. 11, 2006

Related U.S. Application Data
(60) Provisional application No. 60/643,098, filed on Jan. 11, 2005.

(51) Int. Cl. G05D 16/10

(52) U.S. Cl. 137/505.41

(57) ABSTRACT

A regulator assembly for use with a supply of pressurized gas. A plurality of Belleville springs are disposed in a stack with at least one of the Belleville springs disposed in series configuration with at least one other Belleville spring and biased against a piston. The position of the piston is controlled by the pressure downstream of a poppet assembly and the load presented by the Belleville spring stack. The Belleville springs are initially compressed to a point at or near their zero spring rate.

### CROSS-REFERENCE TO RELATED APPLICATION

The present application claims benefit of U.S. Provisional Patent Application No. 60/643,098 filed on Jan. 11, 2005, entitled “Regulator with Selectable Flow Rates and Belleville Springs,” which is incorporated herein by reference.

### FIELD OF THE INVENTION

The present invention relates to a pressure regulator for use with a supply of pressurized gas such as a breathable gas, etc.

### BACKGROUND OF THE INVENTION

It has been known to use coil springs in fluid pressure regulators to counter the force of the regulated pressure. Also, it has been known to use Belleville springs in fluid pressure regulators. Typically, the Belleville spring is used with a coil spring to produce an approximately zero spring rate. In order to do so, the Belleville spring is loaded until it reaches a negative spring rate and this rate is combined with the positive spring rate of the coil spring which results in a combined spring rate that approximates zero.

What is needed is a spring combination that provides a nearly zero spring rate over a range of deflections such that there is less variation in regulated pressure with respect to changes in flow and less variation in flow with respect to changes in pressure.

### SUMMARY OF THE INVENTION

The present invention meets the above-described need by providing a plurality of Belleville-type springs in a stacked, series configuration arranged to obtain a nearly zero spring rate over a range of deflections.

### BRIEF DESCRIPTION OF THE FIGURES

FIG. 1. is a sectional front elevational view of a series arrangement of Belleville springs;

FIG. 2 is a sectional side view of a regulator shown in the flow position with selectable flow rates embodying the present invention; and,

FIG. 3 is a sectional side view of the regulator shown in FIG. 2 in the closed position and rotated approximately ninety degrees.

### DETAILED DESCRIPTION OF THE INVENTION

Fluid pressure regulators typically utilize springs to counter the force of the regulated pressure, and the ability to accurately determine the force of the spring provides for accuracy in the regulated pressure. At lower spring rates (load/deflection), there is less change in force over a given deflection. Accordingly, there is less variation in regulated pressure with respect to changes in flow and less variation in flow with respect to changes in pressure.

The present invention utilizes a plurality of Belleville-type springs arranged in such a fashion to obtain a nearly zero spring rate over a range of deflections.

A single Belleville spring can produce a near zero spring rate over a relatively small region of deflection. As shown in the following graph, a single Belleville spring can be designed to produce a load deflection curve wherein in the range of approximately 0.047 to 0.06 inches (0.013 distance) of deflection, the Belleville spring in this example achieves a nearly zero spring rate at a fixed load such as a 60 lb load.

[image]

By stacking two similar springs in series, the region in which the rate of the two series springs achieve a near zero rate is extended to approximately double, while maintaining the load of a single spring. Likewise, three springs in series would further extend the near zero rate region (see graph below) and four would extend the region even more, while maintaining the load of a single spring.

[image]

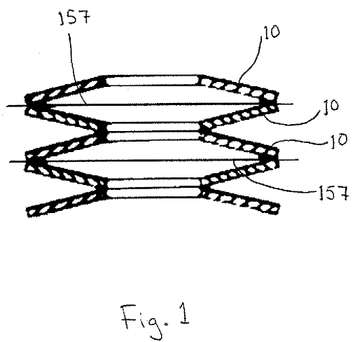

By arranging Belleville springs in series, a near zero rate region of large enough distance can be obtained to utilize the Belleville spring series stack in a pressure regulating valve. As shown in FIG. 1, to stack the Belleville springs 10 in series, the Belleville springs are stacked such that the small diameter of each Belleville spring is closest to the small diameter of the next successive Belleville spring, and the next successive Belleville spring mates to the large diameter of the previous Belleville spring's large diameter. A plate 157 is disposed between opposed springs as shown in FIG. 1. An example of a Belleville spring suitable for use in the present invention is available from the Barnes Group, Inc., Associated Spring Division, Troy, Mich., under CLOVERDOME part number BC1070-025-S. This spring is disclosed in U.S. Pat. No. 6,705,813, which is incorporated herein by reference.

By providing the Belleville springs in a series arrangement, two features are obtained in a pressure regulating valve. First, regardless of the distance the pressure regulating valve has to open, the load on the Belleville spring stack remains the same provided the mechanical travel of the Belleville spring stack stays within the range of nearly zero spring rate. This feature has the effect of keeping the regulated pressure of the pressure regulating valve nearly constant with respect to opening the valve to provide additional flow. Second, a large force can be provided in a very small height.

The compression load that the Belleville spring stack achieves over its near zero rate region may not be repeatable enough for it to be utilized solely in a pressure regulator. Additional compressing or unloading of the Belleville spring stack to achieve a higher or lower load may cause the stack to be compressed outside of its near zero rate region.

Accordingly, in order to provide a fine adjustment for the total spring force, a low rate spring may be utilized in combination with the Belleville spring stack. The second low rate spring may be a coil spring.

In the situation where both springs are used, both the low rate compression coil spring and the Belleville spring stack act upon the pressure sensing element of the pressure regulating valve. The compression of each spring (Belleville stack and low rate compression spring) may be separately controlled. The Belleville spring stack may be compressed to its near zero spring rate region by assembly of close tolerance parts. Alternately, the Belleville spring stack may be set initially by means of a screw or other adjustable member.

The compression of the low rate compression coil spring may be adjusted through the use of a set screw so that precise regulated pressure can be achieved. The percentage of the load counteracted by the Belleville spring stack is much greater than the percentage of the load counteracted by the compression coil spring. Therefore, adjustment of the compression coil spring provides only a fine adjustment of the regulated pressure.

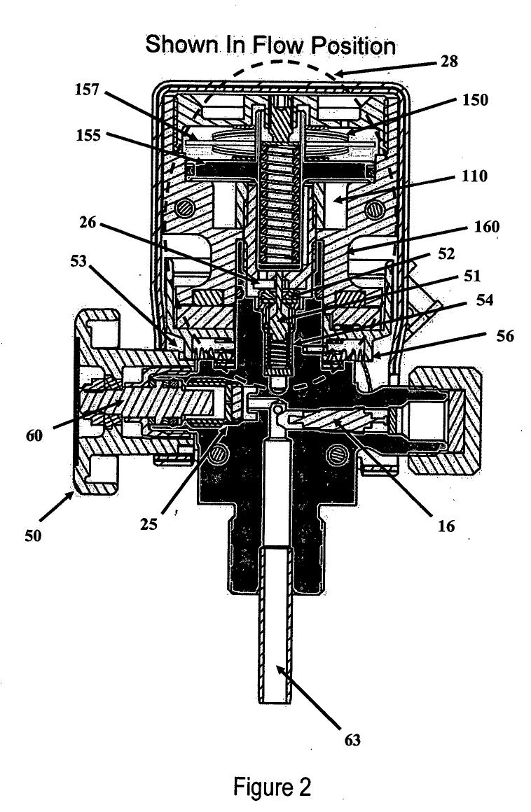

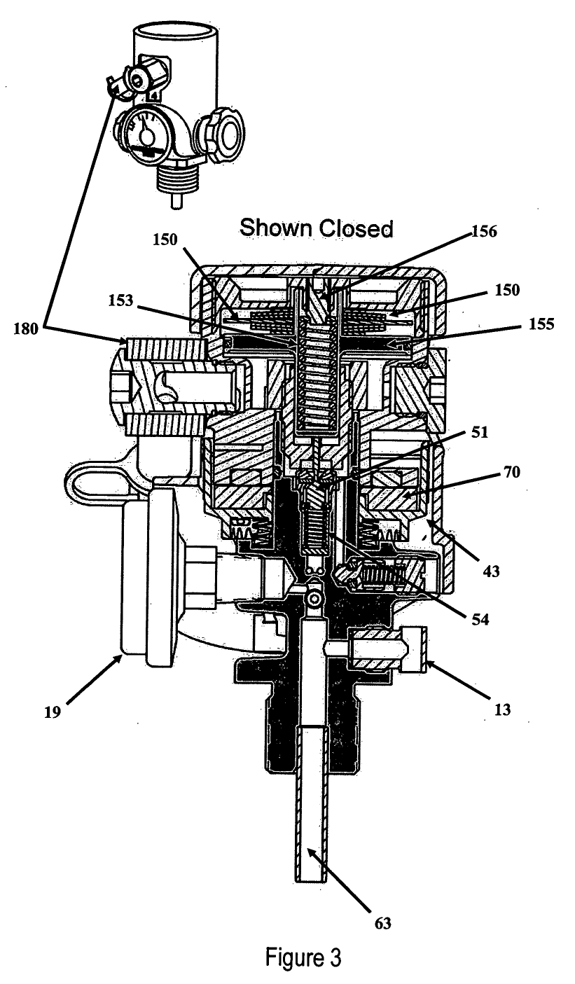

Turning to FIGS. 2-3, an example of the present invention in use with a regulator with selectable flow rates is shown. A central passage 63 communicates storage pressure to the high pressure relief valve 13 (FIG. 3), fill valve 16, storage pressure gauge 19 (FIG. 3) and on/off valve 25. Upon opening the on/off valve by rotating the knob 50, storage pressure is applied to an unbalanced type pressure regulator 28 which reduces it to a lower pressure. The position of a piston 155 is controlled by the pressure downstream of the poppet 51 and the load presented by the Belleville springs. The piston 155 is also in contact with the poppet 51 such that when the pressure in chamber 110 falls below the desired output pressure, the piston 155 is forced downward by the Belleville spring stack 150 and pushes the poppet 51 down away from the regulating orifice 52 allowing more air to flow into chamber 110. When the air pressure in chamber 110 reaches the desired output pressure, piston 155 is moved up away from the poppet 51 by that air pressure. The poppet 51 moves with and maintains contact with the piston 155 by means of a spring 54 pushing on the bottom of the poppet 51. The piston 155 is thereby coupled to the poppet 51. Coupled is defined herein as bringing two physical systems into such relation that the performance of one influences the performance of the other. The upward motion of the poppet 51 restricts the airflow through the regulating orifice 52 thereby preventing the pressure in chamber 110 from going higher than the set point. The air in chamber 110 is delivered to the orifice plate 70 as described below.

The regulated pressure travels through an inlet passage 26 into low pressure chamber 110. This lower regulated pressure is applied to the interface between the low pressure body 160 and the indexer 43 (FIG. 3) as described in greater detail below.

Turning of the knob 50 opens the on/off valve 25 through rotation of shaft 60. The knob 50 is also coupled to the indexer 43 by means of the engagement of the gears 53 attached to the knob 50 with gear 56 attached to or formed integrally with the indexer 43. Accordingly, turning of the knob 50 also causes an orifice plate 70 retained by the indexer 43 to rotate. Rotation of the orifice plate 70 causes the flow setting to switch. The lower pressure gas from chamber 110 passes through a calibrated orifice in the orifice plate 70 to provide a selected flow rate to the outlet 180 as will be evident to those of ordinary skill in the art based on this disclosure. The arrangement of the indexer 43, orifice plate 70, and gear 56 is described in greater detail in U.S. patent application Ser. No. 11/072,156 which is assigned to the assignee of the present invention and is incorporated herein by reference. It is to be understood that the Belleville spring stack of the present invention may also be used with regulators having other outlet configurations as will be evident to those of ordinary skill in the art based on this disclosure.

The Belleville spring stack 150 and the low rate compression spring 153 act on the piston 155 which borders the low pressure chamber 110 to regulate the pressure. As set forth above the majority of the load is counteracted by the Belleville spring stack 150 and the fine adjustment is accomplished by the set screw 156 on the low rate compression spring 153. The compression spring 153 may be configured to work with or against the Belleville springs. In the example shown, the spring works with the Belleville springs. At the position in the spring stack 150 where the edge of one concave spring section meets the edge of another Belleville spring which is concave in the opposite direction, a large flat disk 157 is disposed between the Belleville springs. The disk 157 prevents alignment issues with opposed concave Belleville springs and provides performance as predicted by testing of the individual spring.

While the invention has been described in connection with certain embodiments, it is not intended to limit the scope of the invention to the particular forms set forth, but, on the contrary, it is intended to cover such alternatives, modifications, and equivalents as may be included within the spirit and scope of the invention as defined by the appended claims.

What is claimed is:

1. A regulator assembly for use with a supply of pressurized gas, the regulator assembly comprising:
a passageway from the supply of pressurized gas to a regulator orifice, the regulator orifice in fluid communication with a low pressure chamber;
a poppet assembly disposed adjacent the regulator orifice and capable of controlling flow through the regulator orifice by moving toward and away from the orifice;
a piston disposed in the low pressure chamber and coupled with the poppet assembly such that movement of the piston causes movement of the poppet assembly; and,
a plurality of Belleville springs disposed in a stack and biased against the piston, at least one of the Belleville springs being stacked in series with at least one other Belleville spring, the Belleville springs being compressed to a point at or near their combined zero spring rate.

2. The regulator assembly of claim 1, further comprising a plate disposed between at least two adjacent Belleville springs.

3. The regulator assembly of claim 1, further comprising a low rate compression spring biased against the piston.

4. The regulator assembly of claim 3, wherein the compression of each spring is separately controlled.

5. The regulator assembly of claim 3, wherein the low rate compression spring acts with the Belleville spring stack.

6. The regulator assembly of claim 3, wherein the low rate compression spring acts against the Belleville spring stack.

7. The regulator assembly of claim 3, wherein the low rate compression spring is a coil spring.

8. The regulator assembly of claim 7, wherein the coil spring is adjusted by a set screw.

9. The regulator assembly of claim 1, wherein the plurality of Belleville springs are initially compressed by a set screw.

10. The regulator assembly of claim 1, wherein the plurality of Belleville springs are initially compressed by assembly of the low pressure chamber.

11. A regulator assembly for use with a supply of pressurized gas, the regulator assembly comprising:
a passageway from the supply of pressurized gas to a regulator orifice, the regulator orifice in fluid communication with a low pressure chamber;
a poppet assembly disposed adjacent the regulator orifice and capable of controlling flow through the regulator orifice by moving toward and away from the orifice;
a piston disposed in the low pressure chamber and coupled with the poppet assembly such that movement of the piston causes movement of the poppet assembly;
a plurality of Belleville springs disposed in a stack and biased against the piston, at least one of the Belleville springs being stacked in series with at least one other Belleville spring, the Belleville springs being compressed to a point at or near their combined zero spring rate; and,
a low rate compression spring biased against the piston.

12. The regulator assembly of claim 11, further comprising a plate disposed between at least two adjacent Belleville springs.

13. The regulator assembly of claim 11, wherein the compression of each spring is separately controlled.

14. The regulator assembly of claim 11, wherein the low rate compression spring is a coil spring.

15. The regulator assembly of claim 14, wherein the coil spring is adjusted by a set screw.

16. The regulator assembly of claim 11, wherein the plurality of Belleville springs are initially compressed by a set screw.

17. The regulator assembly of claim 11, wherein the plurality of Belleville springs are initially compressed by assembly of the low pressure chamber.

18. A regulator assembly for use with a supply of pressurized gas, the regulator assembly comprising:
a passageway from the supply of pressurized gas to a regulator valve having an input side and an output side, the output side of the regulator valve in fluid communication with a low pressure chamber;
the low pressure chamber having at least one wall movably responsive to pressure;
a plurality of Belleville springs disposed in a stack and biased against the at least one movably responsive wall, at least one of the Belleville springs being stacked in series with at least one other Belleville spring, the Belleville springs being compressed to a point at or near their combined zero spring rate; and,
wherein the valve is actuated by the motion of the at least one movably responsive wall to produce a supply of gas regulated with respect to pressure.

19. The regulator assembly of claim 18, further comprising a plate disposed between at least two adjacent Belleville springs.

20. The regulator assembly of claim 18, further comprising a low rate compression spring acting in conjunction with the Belleville spring stack to move the at least one wall.
